(19) United States
(12) Patent Application Publication
(10) Pub. No.: US 2005/0193243 A1
(43) Pub. Date: Sep. 1, 2005

(54) METHOD FOR MANAGING A CIRCUIT SYSTEM DURING MODE-SWITCHING

(76) Inventors: Li-Chun Tu, Taipei City (TW); Ping-Sheng Chen, Chia-Yi Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/906,004

(22) Filed: Jan. 30, 2005

(30) Foreign Application Priority Data
Feb. 5, 2004 (TW) 093102698

(51) Int. Cl. G06F 1/26

(52) U.S. Cl. 714/11

(57) ABSTRACT

A method for switching modes of a circuit system. The circuit system includes at least a first memory device, a second memory device, and a microprocessor. The method includes utilizing the second memory device to store a program code division and utilizing the microprocessor to execute the program code division stored in the second memory device so that the microprocessor and the first memory device can accurately switch modes when the circuit system proceeds with mode-switching procedures.

### BACKGROUND

The present invention relates to a method for switching modes of a circuit system, and more particularly to a method of loading a section of program codes to a memory device and executing the section of program codes to avoid failure of a circuit system when the circuit system switches modes.

In recent years, more and more portable electrical devices are produced for satisfying consumers. When users move to other places or let these electrical devices lie idle for a while, these electrical devices are often switched into a power saving mode or are even switched into a shut-down mode. Therefore, when users want to use these portable electrical devices again, they have to switch the electrical devices into an operating mode or to restart these electrical devices. Here, if a restart operation is needed, the circuit within the electrical device has to execute some tests like a power self test, a plug and play test, hardware configuration and so on through a basic input output system (BIOS) stored in a non-volatile memory. After performing the above tests, the circuit loads an operating system, and then the operating system is capable of coordinating operations between the hardware and the related software of the electrical device through settings of the BIOS for activating functionality of the electrical device and restarting the application software. The above-mentioned restart operation is complicated, meaning that users have to wait for a while for the completion of the restart operation. In short, it is not convenient to users.

Therefore, in order to minimize the power consumption of the electrical devices without bringing inconvenience to users, the related art partially cuts off or reduces the electric power generated from a voltage supply of the circuit for switching the circuit into a power saving mode when the circuit is idle. For example, an STR (suspend to RAM) technique is commonly applied to related art desktop and laptop computers for switching the desktop and laptop computers from an operating mode into a sleep mode. Furthermore, when desktop and laptop computers terminate the STR, desktop and laptop computers can quickly return from the sleep mode to the operating mode in only a few seconds without being restarted. FIG. 1 is a block diagram of a circuit system 10 according to the related art. The circuit system 10 can be regarded as a typical access/control system within a normal electrical device. The circuit system 10 comprises a microprocessor 12 and a memory 14. The memory 14 is usually a volatile memory such as a dynamic random access memory (DRAM), and functions as the main memory of the circuit system 10. Taking DRAM for example, the memory 14 operates according to a reference clock CLK, and stores program codes and the operating system. The microprocessor 12 controls operations of the memory 14 and other peripheral devices through accessing the program code stored in the memory 14 for enabling the functionality of the circuit system 10.

As mentioned above, after the circuit system 10 is started and while the circuit system 10 operates, the circuit system 10 loads needed program codes including the operation system, application software, and even part of the BIOS into the memory 14. And the microprocessor 12 executes these program codes to enable functionality of the circuit system 10. When users want to switch the circuit system 10 into a sleep mode (e.g. the STR is utilized), a particular mechanism of the circuit system 10 is triggered to make the circuit system 10 switched from the operating mode into the sleep mode. When the circuit system 10 is going to enter the sleep mode from the operating mode, the microprocessor 12 switches the memory 14 into the sleep mode by controlling the reference clock CLK. For example, the microprocessor 12 can suspend great parts of the operation run by the memory device 14 by cutting off or gating the reference clock CLK. According to the related art, an additional charge circuit can be built inside the DRAM. Furthermore, the charge circuit can refresh data stored in the DRAM periodically, which is called a self-refresh technique. The memory 14 implemented by DRAM can refresh its stored data with the self-refresh technique and reduce the power consumption without relying on the microprocessor 12 or the reference clock CLK provided by other external circuits after entering the sleep mode. After the microprocessor 12 switches the memory 14 into the sleep mode, the circuit system 10 will stop providing the reference clock CLK to the microprocessor 12 and the peripheral devices. Therefore, the circuit system 10 in the sleep mode can reduce power consumption because the microprocessor 12 and the memory 14 stop great parts of the operation so that the power consumption of the circuit system 10 becomes lower. This makes circuit system 10 save a great amount of power. That is why the design of switching modes in the circuit system (such as STR) is implemented.

When the above-mentioned circuit system 10 is switched from the operating mode into the sleep mode, the microprocessor 12 has to execute the program codes (ex. part of the BIOS) stored in the memory 14 to switch the microprocessor 12 from the operating mode into the sleep mode, but before this, the microprocessor 12 has regulated the reference clock CLK to switch the memory 14 into the sleep mode so that the microprocessor 12 can not communicate with the memory 14 entering the sleep mode. It goes without saying that the microprocessor 12 cannot execute the program code stored in the memory 14 to switch the microprocessor 14 into the sleep mode. The above-mentioned problem can be solved by setting up an additional control hardware, which is used to help the microprocessor 12 to control the reference clock CLK or to directly control the reference clock CLK. This allows the microprocessor 12 to switch modes after the microprocessor 12 switches the memory 14 into the sleep mode. However, the first disadvantage of this method is a substantial increase in the hardware cost, and the second disadvantage of this method is that using hardware in a design may cause the disability to dynamically regulate according to the different requirements.

Concerning the function of switching the circuit system 10 into the low-power consumption sleep mode, the circuit system 10 must define a plurality of wake-up events. Generally speaking, when a user triggers a power-on mechanism (ex. a power-on button of the electrical device) of the circuit system 10, one above-mentioned wake-up event takes place and further triggers the circuit system 10 to recover from the sleep mode into the operating mode. Because the microprocessor 12 has to execute the program codes (ex. BIOS) stored in the memory 14 for waking up the other related circuits to leave the sleep mode, the microprocessor 12, which is recovering from the sleep mode into the sleep mode, has to regulate and control the reference clock CLK first (ex. input the reference clock CLK to the memory 14) to switch the memory 14 from the sleep mode into the operating mode, and then accesses the memory 14 and executes the program codes stored in the memory 14 to recover the normal operation of the circuit system 10. However, when the memory 14 has just been woken up, the reference clock CLK may not be stable immediately. While the reference clock CLK is not stable, any data access between the memory 14 and the microprocessor 12 is prone to induce errors. This may cause the microprocessor 12 to execute wrong program codes and instructions, and the circuit system 10 may experience system failures. This problem may even cause non-recoverable damage to the circuit system 10. However, if another control device is utilized to solve the above problem, the production cost of the hardware is increased and the design elasticity is worsened.

### SUMMARY

It is therefore one of the objectives of the claimed invention to provide a method of storing a program code division in another memory device external to the main memory for allowing the microprocessor to correctly execute the program code division, thereby avoiding failure when switching modes of the circuit system and solving the above-mention problem.

The method of the invention is used for switching modes of the circuit system. There are two ways of switching modes in the present invention. These two ways include switching from an operating mode to a sleep mode and switching from a sleep mode to an operating mode. They can be separately regarded as a sleep procedure and a wake-up procedure. Before the sleep/wake-up procedure, another memory device external to the main memory is set up to store a program code division directly related to the operation of the switching modes. On one hand, in the follow-up sleep procedure, the microprocessor can execute the program code division in the memory device to switch itself to the sleep mode and does not have to communicate with the main memory that has almost stopped operating. This can reduce the possibilities of errors. On the other hand, in the follow-up wake-up procedure, when the circuit system has just switched from the sleep mode to the operating mode, the microprocessor can also execute the program code division pre-stored in the memory device and does not have to communicate with the main memory that is not stable yet. So we do not have to worry about the problem of the insufficient stabilities of the reference clock and the main memory.

In the method disclosed in the embodiment of the invention, we separate the program codes into a number of program code divisions. The program code divisions comprise a specific program code division that can provide the control operation for switching modes of the microprocessor. Therefore, if the specific program code division is pre-loaded or pre-stored in a memory device, the microprocessor can execute the program code division and circuit system can switch modes at the same time. Because the operation of switching modes is completed by an elastic software (the program code) and a hardware (the microprocessor), not only is additional hardware not needed, but also the load and the complexity of the circuit system of the invention are lower.

One aspect of the invention is to provide a method that is used for switching modes of a circuit system. The circuit system includes at least a first memory device, a second memory device, and a microprocessor. The method comprises utilizing the second memory device to store a program code division and utilizing the microprocessor to execute the program code division stored in the second memory device so that the microprocessor and the first memory device can accurately switch modes when the circuit system proceeds with mode-switching procedures.

Another aspect of the invention is to provide a method that is used to switch a circuit system from an operating mode to a sleep mode. The circuit system comprises at least a first memory device, a second memory device and a microprocessor. The method comprises:(a) utilizing the second memory device to store a program code division:(b) after step (a), utilizing the microprocessor to execute the program code division stored in the second memory device to switch the first memory device from the operating mode to the sleep mode; and (c) after step (b), utilizing the microprocessor to execute the program code division stored in the second memory device to switch the microprocessor to the sleep mode.

Another aspect is to provide a method that is used to switch the circuit system from a sleep mode to an operating mode. The circuit system comprises at least a first memory device, a second memory device, and a microprocessor. The method comprises:(a) utilizing the second memory device to store a program code division: (b) after step (a), utilizing the microprocessor to execute the program code division stored in the second memory device; and (c) after step (b), utilizing the microprocessor to switch the sleep mode to the operating mode.

### BRIEF DESCRIPTION OF DRAWINGS

FIG. 1 is a block diagram of a circuit system according to the related art.

FIG. 2 is a block diagram of an embodiment of a circuit system according to the present invention.

FIG. 3 is a flow chart illustrating a mode-switching operation according to the present invention.

FIG. 4 is a flow chart illustrating another mode-switching operation according to the present invention.

FIG. 5 is a flow chart summarizing the implementation of the present invention.

### DETAILED DESCRIPTION

The present invention is applied to a sleep procedure and a wake-up procedure. The related circuit system is set to operate under an operating mode and a sleep mode in the following embodiments. In fact, the operating mode and the sleep mode only differ in that the circuit system is either fully operating or partly operating. In practice, the sleep mode can be a standby mode, an idle mode, and a power-off mode according to the degree of power consumption or the status of operation. Although these modes have different definitions, they are regarded as various modes for the circuit system according to the present invention. In other words, the technique disclosed by the present invention is capable of being applied to any operation of switching one mode to another mode.

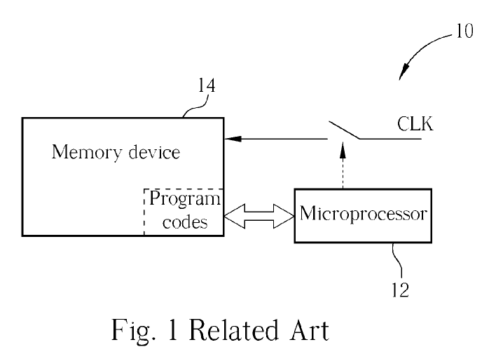

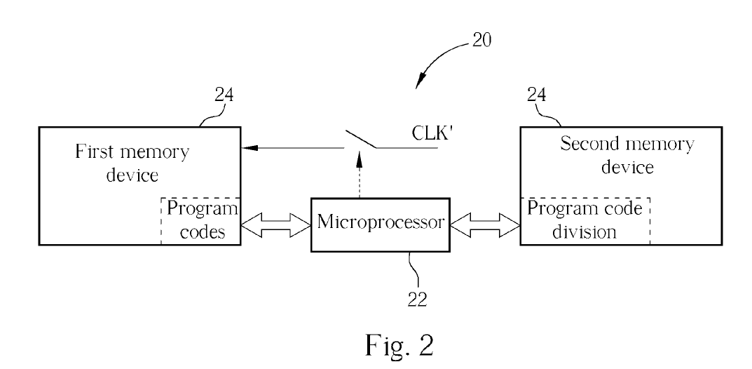

As mentioned above, when the circuit system is switched between several modes, every device within the circuit system is also switched to a corresponding mode. FIG. 2 is a block diagram of a circuit system 20 according to an embodiment of the present invention. The circuit system 20 comprises a first memory device 24, a second memory device 26 and a microprocessor 22. The first memory device 24 corresponds to the memory device 14 (e.g. a main memory) shown in FIG. 1. It can be a DRAM or any other type of volatile memory, and it operates according to a reference clock CLK. The first memory device 24 and the microprocessor 22 are connected to each other. When the circuit system 20 is started, the circuit system 20 will load needed program codes to the first memory device 24 so that the microprocessor 22 can execute the program codes completely in the operating mode for enabling functionality of the circuit system 20.

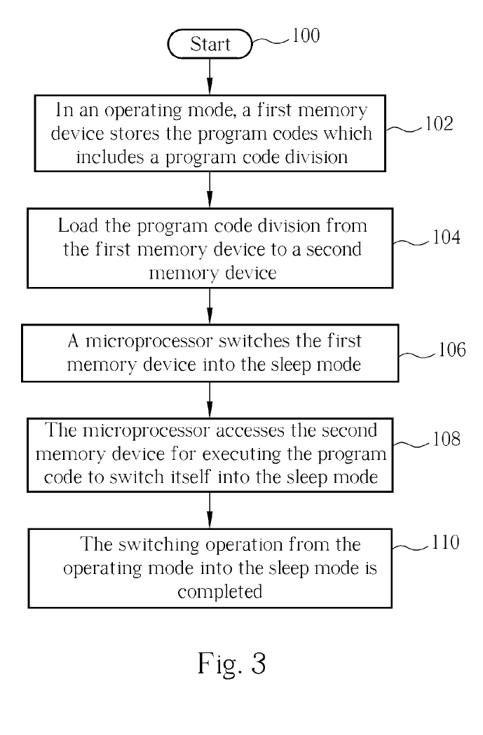

The second memory device 26 is also connected to the microprocessor 22. The second memory device 26 can store a program code division PPC, which is related to the mode-switching operation, for the microprocessor 22 to access and execute. When the second memory device 26 is implemented by an SRAM or a buffer device with low power-consumption, the program codes stored in the first memory device 24 include the program code division PPC. Before switching modes, the circuit system 20 loads the program code division PPC to the second device 26 from the first memory device 24 for the microprocessor 22 to execute the mode-switching operation successfully. Take the circuit system 20 executing a sleep procedure for example. Based on the circuit structure shown in FIG. 2, the operation of the circuit system being switched from the operating mode to the sleep mode is shown in FIG. 3. FIG. 3 is a flow chart illustrating a mode-switching operation according to the present invention.

Step 100: Start;

Step 102: When the circuit system 20 is in the operating mode, the circuit system 20 pre-stores the program codes needed for its operation into the first memory device 24 for the microprocessor 22 to execute the program codes for enabling the functionality of the circuit system 20 in the operating mode. The program codes comprise a plurality of program code divisions, wherein at least one program code division PPC is capable of making the microprocessor 22 switch itself and the first memory device 24 from the operating mode into the sleep mode;

Step 104: When the circuit system 20 is in the operating mode and before a user switches the circuit system 20 into the sleep mode, the circuit system 20 loads the program code division PPC from the first memory device 24 to the second memory device 26. The second memory device 26 can be an SRAM or a buffer device with another type. After the program code division PPC is completely loaded into the second memory device 26, the microprocessor 22 executes program codes stored in the second memory device 26 instead;

Step 106: When the circuit system 20 starts to switch itself from the operating mode into the sleep mode, the microprocessor 22 cuts off or gates the reference clock to switch the first memory device 24 into the sleep mode, or executes the program code division PPC to switch the first memory device 24 into the sleep mode. Suppose that the first memory device 24 is implemented by a DRAM. Under the sleep mode, the first memory device 24 can utilize the related art self-refresh technique to self-refresh its stored data without relying on the microprocessor 22 or the other external circuits. Therefore, the power consumption is lowered;

Step 108: Because the second memory device 26 can keep storing the program code division PPC with only a small amount of electric power when being switched, the microprocessor 22 is allowed to execute the program code division PPC through accessing the second memory device 26 for switching itself into the sleep mode after suspending a great part of the operation run by the first memory device 24. In addition, the program code division PPC stored in the second memory device 26 contains the status of the circuit system 20 before the circuit system 20 enters the sleep mode. It is convenient for the microprocessor 22 to directly execute the BIOS or the operating system stored in the second memory device 22 to make the circuit system 20 return to a normal operation quickly during a wake-up procedure; and

Step 110: The circuit system 20 enters the sleep mode, and the operation of switching the operating mode into the sleep mode is completed.

Please note that the second memory device 26 can be implemented by a read-only memory (ROM), an electrically erasable programmable read-only memory (EEPROM), or any other non-volatile memory. Therefore, the program code division PPC that can switch the microprocessor 22 from the operating mode into the sleep mode in step 102 can be pre-stored in the second memory device 26. This means that the program codes stored in the first memory device 24 do not have to contain the program code division PPC. So, if the second memory device 26 is implemented by a read-only memory, the circuit system 20 does not have to spend much time on loading the program code division PPC from the first memory device 24 to the second memory device 26 before being switched into the sleep mode. In this case, the flow can ignore step 104 shown in FIG. 3, and directly jump from step 102 to step 106. This allows the microprocessor 22 to access the second memory device 26 and execute the program code division PPC to completely switch the circuit system 20 into the sleep mode.

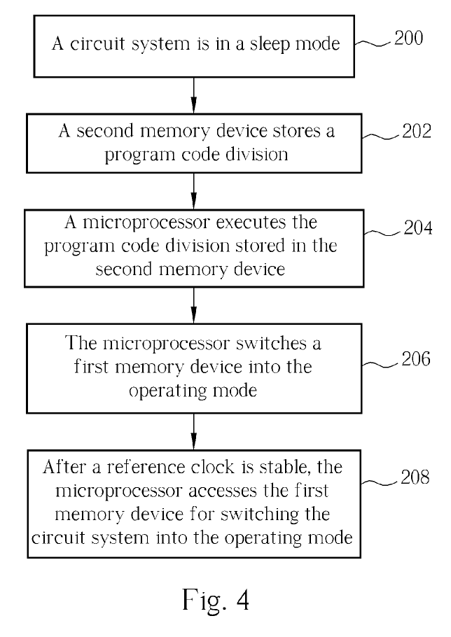

When the user wants to activate the wake-up procedure for recovering the circuit system 20 from the sleep mode to the operating mode, the microprocessor 22 first switches itself from the sleep mode into a mode close to the operating mode, and then recovers the reference clock CLK′ for driving the first memory device 24 to switch the first memory device 24 from the sleep mode into the operating mode through executing the program code division PPC stored in the second memory device 26. So, the microprocessor 22 can firstly execute the program code division PPC stored in the second memory device 26 to perform related controlling operations even though the reference clock CLK′ is unstable immediately when the first memory device is just awaked. According to the circuit structure of the circuit system 20 shown in FIG. 2 and parts of the technical characteristics of the flow shown in FIG. 3, the operation of switching the circuit system 20 from the sleep mode into the operating mode is illustrated in FIG. 4. FIG. 4 is a flow chart illustrating another mode-switching operation according to the present invention.

Step 200: Start;

Step 202: When the circuit system 20 is in the sleep mode, the circuit system 20 has to firstly load the program code division PPC from the first memory device 24 into the second memory device 26 before entering the sleep mode, and the circuit system 20 has to provide a small amount of electric power to keep the program data stored in the second memory device 26 if the second memory device 26 is implemented by a DRAM or a buffer device to store the program code division PPC. However, if the second memory device 26 is implemented by an EPROM or a non-violate memory, the program code division PPC is pre-burned in the second device 26 without losing any data before next time the circuit system 20 is restarted;

Step 204: Utilize the microprocessor 22 to execute the program code division PPC stored in the second memory device 26 when the circuit system 20 wants to switch itself from the sleep mode into the operating mode. In the practical embodiment, as mentioned in step 108 in FIG. 3, the program code division PPC not only controls related operation of switching modes of the microprocessor 22, but also contains the status of the circuit system 20 before circuit system 20 enters the sleep mode. So, after the microprocessor 22 is awaken, the microprocessor 22 is capable of quickly executing parts of the BIOS or the operating system stored in the second memory device 26 for continuing the operation interrupted by the sleep mode, and makes the circuit system 20 again supply the electric power to every peripheral device;

Step 206: At the same time of proceeding step 204, when the circuit system 20 switches itself from the sleep mode to the operating mode, the microprocessor 22 revives the reference clock CLK′ to continue driving the first memory device 24 through executing the program code division PPC. As a result, the first memory device 24 is successfully switched from the sleep mode into the operating mode; and

Step 208: After the operations of the reference clock CLK′ and the first memory device 24 are stable, the microprocessor 22 accesses the first memory device 24 to execute the program codes stored in the first memory device 24 for enabling the whole functionality of the circuit system 20 under the operating mode. Therefore, the operation of switching the sleep mode into operating mode is completed.

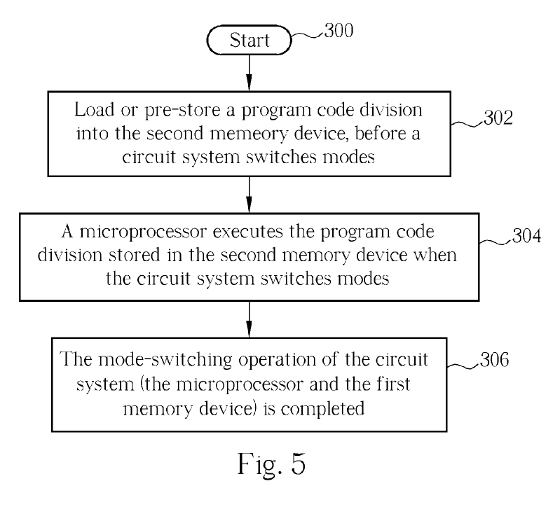

As mentioned above, the present invention utilizes another memory device (such as the second memory device 26 shown in FIG. 2) external to the main memory (such as the first memory device 24 shown in FIG. 2) to pre-store a program code division. Therefore, the microprocessor executes the program code division during the procedure of switching modes and makes the circuit system successfully complete the mode-switching operation. It is obvious that the number or the capacity of the second memory device 26 is not limited. But for reducing cost, only one memory device capable of exactly storing the required program code division is set to achieve the objective of the present invention. FIG. 5 is a flow chart summarizing the implementation of the present invention. The flow chart summarizes the technical characteristics of the present invention, and it still depends on the circuit structure shown in FIG. 2.

Step 300: Start;

Step 302: Before the circuit system 20 switches modes, load or pre-store the program code division PPC to the second memory device 26. The program code division PPC executed by the microprocessor 22 can provide required controlling operations;

Step 304: When the circuit system 20 switches modes, utilize the microprocessor 22 to execute the program code division PPC stored in the second memory device 26 for controlling the reference clock CLK′ and making the microprocessor 22 and the first memory device 24 correctly switch modes; and

Step 306: The circuit system 20 completes the operation of switching modes.

In addition, the first memory device 24 in FIG. 2 can be separately connected to a serial flash memory that having a small size and a small number of pins. The serial flash memory is used to store booting program codes. In the power-on procedure of the circuit system (the power-on procedure can be regarded as an operation of switching a shut-down mode into an operating mode) and before the circuit system loads the booting program codes from the serial flash memory into the first memory device, a specific program code division run by the microprocessor (e.g. the specific program code division can be used for controlling peripheral devices) is pre-loaded or pre-stored into the second memory device. Therefore, the microprocessor is capable of executing the specific program code division to deal with controlling operations required to be completed within a fixed amount of time. So, not only can the circuit system avoid unwanted errors, but also the circuit system according to the present invention has better design elasticity and an advantage of the price. As mentioned before, the technical characteristics disclosed in the present invention can be applied in switching all kinds of modes, and is capable of improving the stability of the circuit system during the execution of the mode-switching operation. To sum up, the method according to the present invention guarantees that the circuit system can switch modes successfully.

1. A method used for switching modes of a circuit system, the circuit system including at least a first memory device, a second memory device, and a microprocessor, the method comprising:
utilizing the second memory device to store a program code division; and
utilizing the microprocessor to execute the program code division stored in the second memory device so that the microprocessor and the first memory device can accurately switch modes when the circuit system proceeds with mode-switching procedures.

2. The method of claim 1 further comprising:
utilizing the first memory device to store a number of program code divisions; and loading the program code divisions from the first memory device into the second memory device.

3. The method of claim 1 wherein the circuit system operates in an operating mode and in a sleep mode, the method further comprising:
utilizing the microprocessor to switch the first memory device to the sleep mode when the circuit system switches itself from the operating mode to the sleep mode; and
utilizing the microprocessor to execute the program code division stored in the second memory device to switch the microprocessor to the sleep mode.

4. The method of claim 3 further comprising:
utilizing the microprocessor to control a reference clock to switch the first memory from the operating mode to the sleep mode when the circuit system switches itself from the operating mode to the sleep mode.

5. The method of claim 3 further comprising:
utilizing the microprocessor to execute the program code division stored in the second memory device to switch the microprocessor to the operating mode when the circuit system switches from the sleep mode to the operating mode; and
utilizing the microprocessor to switch the first memory device from the sleep mode to the operating mode when the circuit system switches itself from the sleep mode to the operating mode.

6. The method of claim 5 further comprising:
utilizing the microprocessor to control a reference clock to switch the first memory device from the sleep mode to the operating mode when the circuit system switches itself from the sleep mode to the operating mode.

7. The method of claim 1 wherein the first memory device is a dynamic random access memory (DRAM), and the second memory device is a read-only memory (ROM), an electrically erasable programmable read-only memory (EEPROM), a static random access memory (SRAM), or a buffer device.

8. A method used for switching a circuit system from an operating mode to a sleep mode, the circuit system comprising at least a first memory device, a second memory device and a microprocessor, the method comprising:
(a) utilizing the second memory device to store a program code division;
(b) utilizing the microprocessor to execute the program code division stored in the second memory device for switching the first memory device from the operating mode to the sleep mode after step (a); and
(c) utilizing the microprocessor to execute the program code division stored in the second memory device for switching the microprocessor to the sleep mode after step (b).

9. The method of claim 8 further comprising:
(d) utilizing the first memory device to store a number of program code divisions before step (a), wherein the number of program code divisions comprises the program code division; and
(e) after step (d) but in step (a), loading the program code division from the first memory device into the second memory device.

10. The method of claim 9 wherein the second memory device is a static random access memory (SRAM) or a buffer device.

11. The method of claim 9 further comprising:
(f) in step (b), utilizing the microprocessor to control a reference clock to switch the first memory device from the operating mode to the sleep mode.

12. The method of claim 8 wherein the first memory device is a dynamic random access memory (DRAM).

13. A method used for switching the circuit system from a sleep mode to an operating mode, the circuit system comprising at least a first memory device, a second memory device, and a microprocessor, the method comprising:
(a) utilizing the second memory device to store a program code division;
(b) after step (a), utilizing the microprocessor to execute the program code division stored in the second memory device; and
(c) after step (b), utilizing the microprocessor to switch the sleep mode to the operating mode.

14. The method of claim 13 further comprising:
(d) before the step (a), utilizing the first memory device to store a number of program code divisions wherein the number of program code divisions comprises the program code division; and
(e) after step (d) and before the circuit system is switched to the sleep mode, loading the program code division from the first memory device to the second memory device.

15. The method of claim 14 wherein the second memory device is a static random access memory (SRAM) or a buffer device.

16. The method of claim 13 further comprising:
(f) in step (c), utilizing the microprocessor to control a reference clock to switch the first memory device from the sleep mode to the operating mode.

17. The method of claim 13 wherein the first memory device is a dynamic random access memory (DRAM), and the second memory device is a read-only memory (ROM), an electrically erasable programmable read-only memory (EEPROM), an SRAM, or a buffer device.
